(19) United States
(12) Patent Application Publication
(10) Pub. No.: US 2017/0279738 A1
(43) Pub. Date: Sep. 28, 2017

(54) METHOD, APPARATUS, AND SYSTEM FOR TRANSMITTING DATA

(71) Applicants: Le Holdings(Beijing)Co., Ltd, Beijing (CN); Le Cloud Computing Co., Ltd., Beijing (CN)

(72) Inventor: Jun CAI, Beijing (CN)

(21) Appl. No.: 15/247,893

(22) Filed: Aug. 25, 2016

Related U.S. Application Data
(63) Continuation of application No. PCT/CN2016/088991, filed on Jul. 6, 2016.

(30) Foreign Application Priority Data
Mar. 25, 2016 (CN) 201610179918.6

(51) Int. Cl. H04L 12/911; H04L 29/08

(52) U.S. Cl. CPC H04L 47/822; H04L 67/10

(57) ABSTRACT

Embodiments of the application provide a method, apparatus, and system for transmitting data. In the solution of the application, a client determines at least two data transmission paths between the client and a transmission service platform, and selects at least two of the determined data transmission paths; segments data to be transmitted into at least two data blocks; transmits associated information of respective data blocks to the transmission service platform; and transmits the at least two data blocks into which the data are segmented to the transmission service platform over he selected respective data transmission paths. In the embodiments of the application, the data to be transmitted are segmented into a plurality of data blocks, and then the data are transmitted concurrently over the at least two data transmission paths, thus improving the efficiency of data transmission over the prior art where the data are transmitted over only one data transmission path.

### CROSS REFERENCE TO RELATED APPLICATIONS

This application is a continuation of International Application No. PCT/CN2016/088991, filed on Jul. 6, 2016, which is based upon and claims priority to Chinese Patent Application No. 201610179918.6, filed on Mar. 25, 2016, the entire contents of which are incorporated herein by reference.

### TECHNICAL FIELD

The present application relates to the field of communications, and particularly to a method, apparatus, and system for transmitting data.

### BACKGROUD

Data transmission is an important function of a network. As the communication technologies are being developed and improved constantly, more and more data are transmitted from one node to another node over the network. Moreover the amount of data also comes to be growing, thus resulting in an increasing demand for the network.

The inventors have identified during making of the application that data are transmitted over a single data transmission path in the existing solution. An available bandwidth over the single data transmission path may drop due to other services in the network, thus resulting in degrading the speed of data transmission, or the network may fail, thus interrupting transmission of the data, so that a retransmission mechanism has to be applied after transmission of the data is interrupted. However the retransmission mechanism in the prior art may be so imperfect that transmission of the data consumes considerable time and network processing resources. In view of this, the solution to data transmission in the prior art may suffer from the problems of low transmission efficiency and poor error tolerance.

### SUMMARY

Embodiments of the application provide a method, apparatus, and system for transmitting data so as to address the problem in the prior art of low transmission efficiency and poor error tolerance arising from the single data transmission path.

Particular technical solutions according to the embodiments of the application are as follows:

In an aspect, an embodiment of the application provides a method for transmitting data, the method including:

determining, by a client, at least two data transmission paths between the client and a transmission service platform, and selecting at least two of the determined data transmission paths;

segmenting data to be transmitted into at least two data blocks; and transmitting associated information of respective data blocks to the transmission service platform, wherein the associated information identifies the data to be transmitted to which the data blocks belong; and

transmitting the data blocks into which the data are segmented to the transmission service platform over the selected at least two data transmission paths.

In another aspect, an embodiment of the application provides a method for transmitting data, the method including:

receiving, by a transmission service platform, associated information of data blocks transmitted by a client, wherein the associated information identifies data to be transmitted to which the data blocks belong;

receiving the data blocks transmitted by the client over selected at least two data transmission paths; and

determining the data blocks belonging to the same data to be transmitted, according to the associated information.

In another aspect, an embodiment of the application provides an apparatus for transmitting data, the apparatus including:

a path obtaining module configured to obtain at least two data transmission paths between the apparatus and a transmission service platform, and to select at least two of the determined data transmission paths;

a segmenting module configured to segment data to be transmitted into at least two data blocks; and to transmit associated information of respective data blocks to the transmission service platform, wherein the associated information identifies the data to be transmitted to which the data blocks belong; and

a transmitting module configured to transmit the data blocks into which the data are segmented to the transmission service platform over the selected at least two data transmission paths.

In another aspect, an embodiment of the application provides an apparatus for transmitting data, the apparatus including:

a associated information receiving module configured to receive associated information of data blocks transmitted by a client, wherein the associated information identifies data to be transmitted to which the data blocks belong;

a data block receiving module configured to receive the data blocks transmitted by the client over selected at least two data transmission paths; and

a determining module configured to determine the data blocks belonging to the same data to be transmitted, according to the associated information.

In another aspect, an embodiment of the application provides a system for transmitting data, the system including:

a client configured to determine at least two data transmission paths between the client and a transmission service platform, and to select at least two of the determined data transmission paths; to segment data to be transmitted into at least two data blocks; to transmit associated information of respective data blocks to the transmission service platform, wherein the associated information identifies the data to be transmitted to which the data blocks belong; and to transmit the data blocks into which the data are segmented to the transmission service platform over the selected at least two data transmission paths; and

the transmission service platform configured to receive the associated information of the data blocks transmitted by the client; to receive the data blocks transmitted by the client over the selected at least two data transmission paths; and to determine the data blocks belonging to the same data to be transmitted, according to the associated information.

An advantageous effect of the embodiments of the application lies in that the client determines at least two data transmission paths between the client and the transmission service platform, and selects at least two of the determined data transmission paths; segments the data to be transmitted into at least two data blocks; and then allocates the at least two data blocks into which the data are segmented to the selected respective data transmission paths for transmission to the transmission service platform. Thus in the embodiments of the application, the data to be transmitted are segmented into a number of data blocks, and then the data are transmitted concurrently over the at least two data transmission paths, thus improving the efficiency of data transmission over the prior art where the data are transmitted over only one data transmission path.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for transmitting data according to a first embodiment of the application;

FIG. 2 is an exemplary flow chart of a method for transmitting data according to a second embodiment of the application;

FIG. 3 is an exemplary flow chart of a method for transmitting data according to a third embodiment of the application;

FIG. 4 is a schematic structural diagram of an apparatus for transmitting data according to a fourth embodiment of the application;

FIG. 5 is a schematic structural diagram of an apparatus for transmitting data according to a fifth embodiment of the application; and

FIG. 6 is a schematic structural diagram of an apparatus for transmitting data according to a sixth embodiment of the application.

### DETAILED DESCRIPTION

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

In the embodiments of the application, a client determines at least two data transmission paths between the client and a transmission service platform, and selects at least two of the determined data transmission paths; segments data to be transmitted into at least two data blocks; and then allocates the at least two data blocks into which the data are segmented to the selected respective data transmission paths for transmission to the transmission service platform. Thus in the embodiments of the application, the data to be transmitted are segmented into a number of data blocks, and then the data are transmitted concurrently over the at least two data transmission paths, thus improving the efficiency of data transmission over the prior art where the data are transmitted over only one data transmission path.

In order to facilitate further understanding, the technical solutions according to the embodiments of the application will be described below.

### First Embodiment

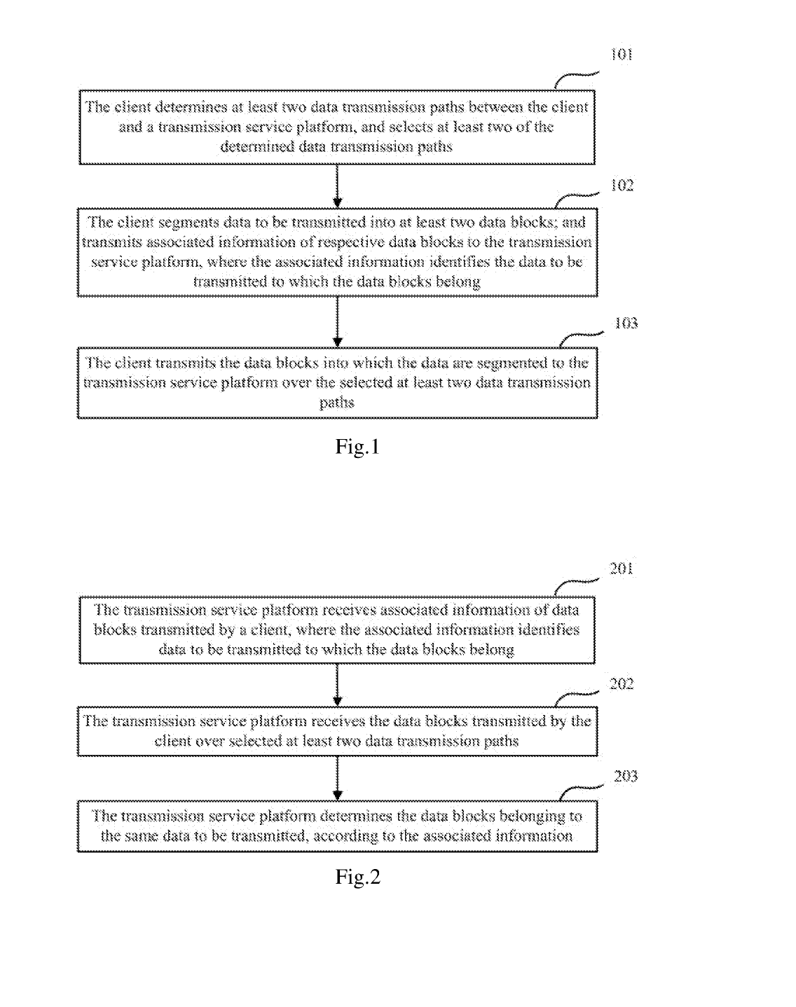

As illustrated in FIG. 1, there is a schematic flow chart of a method for transmitting data according to an embodiment of the application, where the method applicable to a client includes the following steps:

In the step 101, the client determines at least two data transmission paths between the client and a transmission service platform, and selects at least two of the determined data transmission paths.

In an embodiment of the application, the client can be a client of a mobile terminal, e.g., a client of a mobile phone, or can be a client of an immobile terminal, e.g., a client of a desktop computer, etc.

In the step 102, the client segments data to be transmitted into at least two data blocks; and transmits associated information of respective data blocks to the transmission service platform, where the associated information identifies the data to be transmitted to which the data blocks belong.

Here the execution sequence of the step 101 and the step 102 is not limited.

Here in an embodiment, the associated information can include unique identifies of respective data blocks, e.g., sequence numbers of respective data blocks. Of course, the associated information can alternatively be determined as in the prior art as long as the transmission service platform can determine which data blocks belong to the same data to be transmitted, so the embodiment of the application will not be limited thereto.

In the step 103, the client transmits the data blocks into which the data are segmented to the transmission service platform over the selected at least two data transmission paths.

Thus the transmission service platform can determine the data blocks belonging to the same data to be transmitted, according to the associated information upon reception of the data blocks.

Thus in the embodiment of the application, the data to be transmitted are segmented into a number of data blocks, and then the data are transmitted concurrently over at least two data transmission paths, and the associated information of the data blocks are transmitted to the transmission service platform, so that the transmission service platform can determine which data blocks belong to the same data to be transmitted, thus improving the efficiency of data transmission over the prior art where the data are transmitted over only one data transmission path.

Here in an embodiment, even if the data are transmitted over a number of data transmission paths, transmission rates of the data transmission path may drop due to a variety of reasons so that they are not inappropriate for further transmission of the data to be transmitted, thus degrading the stability of transmitting the data to be transmitted. In view of this, in an embodiment of the application, in order to improve the stability of data transmission, the method can further include the following steps while the data blocks into which the data are segmented are being transmitted concurrently to the transmission service platform over the selected at least two data transmission paths:

The step A1 is to detect transmission rates of the selected respective data transmission paths;

The step A2 is to determine, for any one of the selected data transmission paths, whether the transmission rate thereof is less than a preset rate; and

The step A3 is, if the transmission rate is less than a preset rate, to allocate the data blocks to be transmitted, allocated to the data transmission path, to a data transmission path with the transmission rate more than the preset rate.

Here the data transmission path with the transmission rate more than the preset rate in the step A3 can be one of the selected at least two data transmission paths. For example, the previously selected data transmission paths are L1, L2, and L3, and if the transmission rate of L1 is less than the preset rate, then the data blocks to be transmitted of L1 will be allocated to L2 for transmission. The data transmission path with the transmission rate more than the preset rate in the step A3 can alternatively be one of the data transmission paths which are not selected in the step 101. For example, there are four data transmission paths in total L1, L2, L3, and L4 between the client and the transmission service platform, where L1, L2, and L3 are selected for transmission of the data blocks, and thereafter if the detected transmission rate of L1 is less than the preset rate, and transmission rate of L4 is more than the preset rate, then the data blocks to be transmitted of L1 will be allocated to L4 for transmission.

Here in an embodiment, if the transmission rate of the data transmission path is not less than the preset rate, then the data blocks allocated thereto will be further transmitted over the data transmission path.

For example, the data to be transmitted are segmented into 15 data blocks, and the data blocks are allocated equally to the three data transmission paths numbered L1, L2 and L3 for transmission, that each data transmission path is responsible for transmitting 5 data blocks. During transmission of the data, if the transmission rate of L1 is less than the preset rate after 3 data blocks are transmitted, and both the transmission rates of the other two data transmission paths (L2 and L3) are more than or equal to the preset rate, then the remaining two data blocks of L1 will be allocated to L2 and/or L3 for transmission to thereby guarantee the stability of data transmission.

Here in an embodiment, in order to enable clients developed in various development languages to transmit data to the transmission service platform, the step 103 can be performed in an embodiment of the application by invoking a general-purpose interface to transmit the data blocks into which the data are segmented to the transmission service platform over the selected at least two data transmission paths, where the general-purpose interface is designed in the Software Development Kit (SDK). The clients in any development language and/or any version can invoke the general-purpose interface, so that the clients in any development language and/or any version can be supported via the general-purpose interface.

Here in an embodiment, in order to enable clients developed in various development languages to transmit data to the transmission service platform, the step 103 can alternatively be performed in an embodiment of the application by transmitting the data blocks into which the data are segmented to the transmission service platform over the selected at least two data transmission paths in a general-purpose proxy protocol which is the Hyper Text Transfer Protocol (HTTP), Socket, or another general-purpose proxy protocol, for example.

Here in an embodiment, the data transmission paths in the embodiment of the application can be a number of data transmission links established by the same client, or can be data transmission paths between the same client and the transmission service platform, which are established via respective ones of at least two network cards of the client, or can include both the data transmission links and the data transmission paths between a client and a transmission service platform via network cards, so the embodiment of the application will not be limited thereto.

Here in an embodiment, the transmission rates of respective data transmission paths can be represented as qualities of signals of respective network cards, or can be represented as load bandwidths of respective data transmission paths.

In summary, in the embodiment of the application, the data to be transmitted are allocated to a number of data transmission paths, and during transmission of the data, respective data transmission paths are replaced in a timely manner according to the transmission rates of the data transmission paths to transmit the remaining data blocks, so that transmission of the data can be adapted dynamically to the network environment to thereby enable the data to be transmitted efficiently and stably to the transmission service platform.

### Second Embodiment

Based upon the same inventive concept, an embodiment of the application provides a method for transmitting data, the method being applicable to a transmission service platform. As illustrated in FIG. 2, there is a schematic flow chart of the method including the following steps:

In the step 201, the transmission service platform receives associated information of data blocks transmitted by a client, where the associated information identifies data to be transmitted to which the data blocks belong.

In the step 202, the transmission service platform receives the data blocks transmitted by the client over selected at least two data transmission paths.

Here the data blocks are generated by the client segmenting the data to be transmitted.

In the step 203, the transmission service platform determines the data blocks belonging to the same data to be transmitted, according to the associated information.

For example, the associated information includes a data identifier of the data to be transmitted, and sequence numbers of the data blocks, for example, if data to be transmitted A includes three data blocks with sequence numbers of 1, 2, and 3 respectively, then associated information of these three data blocks can be represented respectively as A-1, A-2, and A-3, so the server can determine from the associated information that the three data blocks A-1, A-2, and A-3 belong to the same data to be transmitted.

Here in an embodiment, the transmission service platform can further performs data processing on and then transmit the received data blocks to the client requesting for downloading the data blocks, upon reception of the data blocks, where the data processing is data processing performed for the client requesting for live data blocks, e.g., cloud transcoding, etc.

Of course, the transmission service platform can also store the data blocks upon reception thereof.

Here in an embodiment, in order to enable clients in various development languages to transmit data, the step 202 can be performed in the embodiment of the application particularly by receiving the data blocks transmitted by the client over the selected at least two data transmission paths by invoking the same interface, in a preset set of general-purpose interfaces, as a development language of the client.

Here in an embodiment, in order to enable clients in various development languages to transmit data, the step 202 can alternatively be performed in the embodiment of the application particularly by receiving the data blocks transmitted by the client over the selected at least two data transmission paths in a general-purpose proxy protocol.

Here in an embodiment, the same data to be transmitted are transmitted over the different data transmission paths operating in different proxy protocols.

In the embodiment of the application, the transmission service platform receives the data blocks transmitted by the client over a plurality of data transmission paths to thereby improve the efficiency of data transmission.

### Third Embodiment

With the technical solutions according to the embodiments of the application, the data to be transmitted can be transmitted concurrently over a plurality of data transmission paths, and during transmission of the data, respective data transmission paths can be adjusted dynamically according to the transmission rates of the data transmission paths to transmit the remaining data blocks, so that a large amount of data can be transmitted in real time in the embodiments of the application.

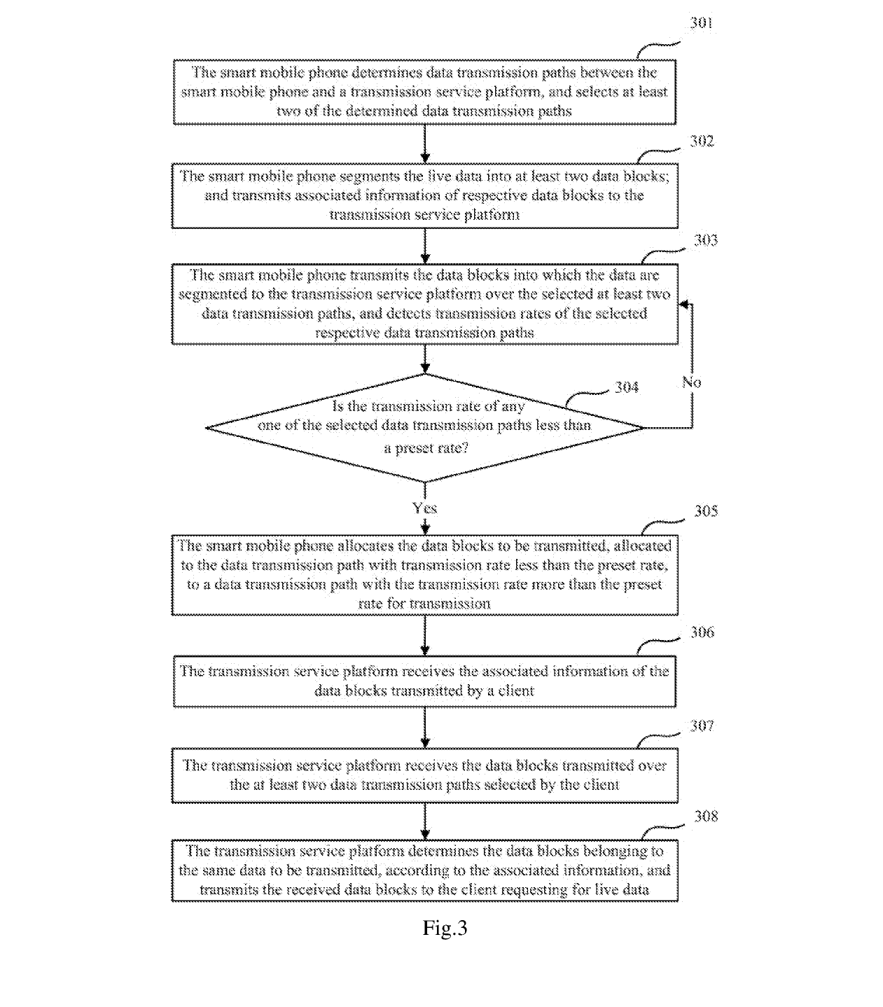

A method for transmitting data according to an embodiment of the application will be described below by way of an example where a smart mobile phone transmits live data. As illustrated in FIG. 3, there is a schematic flow chart of the transmitting method including the followings steps:

In the step 301, the smart mobile phone determines data transmission paths between the smart mobile phone and a transmission service platform, and selects at least two of the determined data transmission paths.

In the step 302, the smart mobile phone segments the live data into at least two data blocks; and transmits associated information of respective data blocks to the transmission service platform.

In the step 303, the smart mobile phone transmits the data blocks into which the data are segmented to the transmission service platform over the selected at least two data transmission paths, and detects transmission rates of the selected respective data transmission paths.

In the step 304, the smart mobile phone determines, for any one of the selected data transmission paths, whether the transmission rate thereof is less than a preset rate, and if the transmission rate is less than a preset rate, then the flow will proceed to the step 305; otherwise, the flow will proceed to the step 304.

In the step 305, the smart mobile phone allocates the data blocks to be transmitted, allocated to the data transmission path with transmission rate less than the preset rate, to a data transmission path with the transmission rate more than the preset rate for transmission.

In the step 306, the transmission service platform receives the associated information of the data blocks transmitted by a client.

In the step 307, the transmission service platform receives the data blocks transmitted over the at least two data transmission paths selected by the client.

In the step 308, the transmission service platform determines the data blocks belonging to the same data to be transmitted, according to the associated information, and transmits the received data blocks to the client requesting for live data.

Here in an embodiment, the transmission service platform can alternatively perform data processing on and then transmit the received data blocks to the client requesting for downloading the data blocks, where the data processing is data processing performed for the client requesting for live data blocks, e.g., cloud transcoding, etc.

Of course, the transmission service platform can also store the data blocks upon reception thereof.

Here an embodiment of the application will be described by way of an example where a mobile phone transmits data to a transmission service platform over a plurality of data transmission paths established via at least two network cards (e.g., a network card 1, a network card 2, and a network card 3): the mobile phone segments the data to be transmitted into at least two data blocks, allocates the at least two data blocks to the network card 1, the network card 2, and the network card 3, and transmits the data blocks concurrently to the transmission service platform; and the mobile phone detects transmission rates of respective network cards, and if the transmission rate of one of the network cards is less than a preset rate, then the mobile phone will reallocate the data blocks to be transmitted of the network card with the transmission rate less than the preset rate, to a network card with the transmission rate more than or equal to the preset rate for transmission, so that even if the mobile phone resides on a vehicle traveling at a high speed, and has its serving base station handed over all the time, then the mobile phone can detect the transmission rates of respective network cards, and thus switch the network cards (i.e., switch data transmission paths) in a timely manner to transmit the data for the purpose of transmitting the data in real time so as to improve the efficiency and stability of transmitting the data.

### Fourth Embodiment

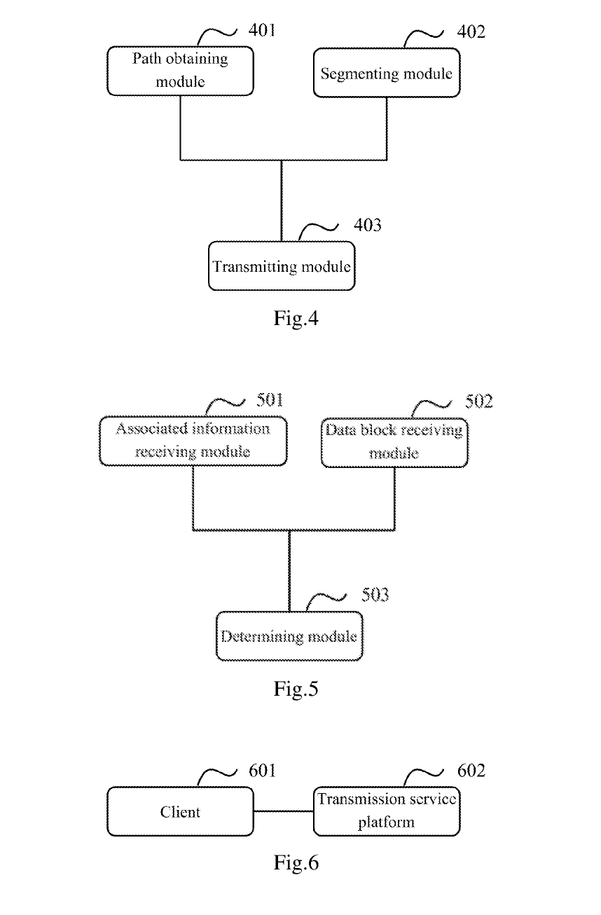

Based upon the same inventive concept, an embodiment of the application further provides an apparatus for transmitting data, and as illustrated in FIG. 4, there is a schematic structural diagram of the apparatus including:

A path obtaining module 401 is configured to obtain at least two data transmission paths between the apparatus and a transmission service platform, and to select at least two of the determined data transmission paths;

A segmenting module 402 is configured to segment data to be transmitted into at least two data blocks; and to transmit associated information of respective data blocks to the transmission service platform, where the associated information identifies the data to be transmitted to which the data blocks belong, so that the transmission service platform determines the data blocks belonging to the same data to be transmitted, according to the associated information; and

A transmitting module 403 is configured to transmit the data blocks into which the data are segmented to the transmission service platform over the selected at least two data transmission paths.

Here in an embodiment, the apparatus further includes:

A detecting module is configured to detect transmission rates of the selected respective data transmission paths, while the transmitting module is transmitting the at least two data blocks into which the data are segmented to the transmission service platform over the data transmission paths after allocating the data blocks to the selected respective data transmission paths;

A determining module is configured to determine, for any one of the selected data transmission paths, whether the transmission rate thereof is less than a preset rate; and

An adjusting module is configured, if a result of the determination by the determining module is positive, to allocate the data blocks to be transmitted, allocated to the data transmission path with the transmission rate less than the preset rate, to a data transmission path with the transmission rate more than the preset rate.

Here in an embodiment, the transmitting module is configured:

To invoke a general-purpose interface to transmit the at least two data blocks into which the data are segmented to the transmission service platform over the selected respective data transmission paths after the data blocks allocated to the data transmission paths.

Here in an embodiment, the transmitting module is configured:

To transmit the at least two data blocks into which the data are segmented to the transmission service platform over the selected respective data transmission paths in a general-purpose proxy protocol, after the data blocks allocated to the data transmission paths.

In the embodiments of the application, the data to be transmitted are segmented into the data blocks, and then the data blocks are allocated to a plurality of data transmission paths for transmission of the data to be transmitted; and during transmission of the data, respective data transmission paths are replaced in a timely manner according to the transmission rates of the data transmission paths to transmit the remaining data blocks, so that transmission of the data can be adapted dynamically to the network environment to thereby enable the data to be transmitted efficiently and stably to the transmission service platform.

### Fifth Embodiment

Based upon the same inventive concept, an embodiment of the application further provides an apparatus for transmitting data, and as illustrated in FIG. 5, there is a schematic structural diagram of the apparatus including:

A associated information receiving module 501 is configured to receive associated information of data blocks transmitted by a client, where the associated information identifies data to be transmitted to which the data blocks belong;

A data block receiving module 502 is configured to receive the data blocks transmitted by the client over selected at least two data transmission paths; and

A determining module 503 is configured to determine the data blocks belonging to the same data to be transmitted, according to the associated information.

Here in an embodiment, the data block receiving module is configured:

To receive the data blocks transmitted by the client over the selected at least two data transmission paths by invoking the same interface in a preset set of general-purpose interfaces as a development language of the client.

Here in an embodiment, the data block receiving module is configured:

To receive the data blocks transmitted by the client over the selected at least two data transmission paths in a general-purpose proxy protocol.

In the embodiments of the application, the transmission service platform receives the data blocks transmitted by the client over a plurality of data transmission paths to thereby improve the efficiency of data transmission.

### Sixth Embodiment

Based upon the same inventive concept, an embodiment of the application further provides a system for transmitting data, and as illustrated in FIG. 6, there is a schematic structural diagram of the system including:

A client 601 is configured to obtain at least two data transmission paths between the client and a transmission service platform, and to select at least two of the determined data transmission paths; to segment data to be transmitted into at least two data blocks; to transmit associated information of respective data blocks to the transmission service platform, where the associated information identifies the data to be transmitted to which the data blocks belong; and to allocate the data blocks into which the data are segmented to the selected respective data transmission paths, and to transmit the data blocks to the transmission service platform over the data transmission paths; and

The transmission service platform 602 is configured to receive the associated information of the data blocks transmitted by the client; to receive the data blocks transmitted by the client over the selected at least two data transmission paths; and to determine the data blocks belonging to the same data to be transmitted, according to the associated information.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the application. This can be understood and practiced by those ordinarily skilled in the art without any inventive effort.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A method for transmitting data, the method comprising:
determining, by a client, at least two data transmission paths between the client and a transmission service platform, and selecting at least two of the determined data transmission paths;
segmenting data to be transmitted into at least two data blocks; and transmitting associated information of respective data blocks to the transmission service platform, wherein the associated information identifies the data to be transmitted to which the data blocks belong; and
transmitting the data blocks into which the data are segmented to the transmission service platform over the selected at least two data transmission paths.

2. The method according to claim 1, wherein while the data blocks into which the data are segmented are being transmitted to the transmission service platform over the selected at least two data transmission paths, the method further comprises:
detecting transmission rates of the selected respective data transmission paths;
determining, for any one of the selected data transmission paths, whether the transmission rate thereof is less than a preset rate; and
if the transmission rate is less than a preset rate, then allocating the data blocks to be transmitted, allocated to the data transmission path with the transmission rate less than the preset rate, to a data transmission path with the transmission rate more than the preset rate.

3. The method according to claim 1, wherein transmitting the data blocks into which the data are segmented to the transmission service platform over the selected at least two data transmission paths comprises:
invoking a general-purpose interface to transmit the data blocks into which the data are segmented to the transmission service platform over the selected at least two data transmission paths.

4. The method according to claim 1, wherein transmitting the data blocks into which the data are segmented to the transmission service platform over the selected at least two data transmission paths comprises:
transmitting the data blocks into which the data are segmented to the transmission service platform over the selected at least two data transmission paths in a general-purpose proxy protocol.

5. An apparatus for transmitting data, the apparatus comprising:
at least one processor; and
a memory communicably connected with the at least one processor for storing instructions executable by the at least one processor, wherein execution of the instructions by the at least one processor causes the at least one processor to:
obtain at least two data transmission paths between the apparatus and a transmission service platform, and select at least two of the determined data transmission paths;
segment data to be transmitted into at least two data blocks; and transmit associated information of respective data blocks to the transmission service platform, wherein the associated information identifies the data to be transmitted to which the data blocks belong; and
transmit the data blocks into which the data are segmented to the transmission service platform over the selected at least two data transmission paths.

6. The apparatus according to claim 5, wherein the execution of the instructions by the at least one processor further causes the at least one processor to:
detect transmission rates of the selected respective data transmission paths while the transmitting module is transmitting the at least two data blocks into which the data are segmented to the transmission service platform over the selected data transmission paths after allocating the data blocks to the respective data transmission paths;
determine, for any one of the selected data transmission paths, whether the transmission rate thereof is less than a preset rate; and
if a result of the determination by the determining module is positive, allocate the data blocks to be transmitted, allocated to the data transmission path with the transmission rate less than the preset rate, to a data transmission path with the transmission rate more than the preset rate.

7. The apparatus according to claim 5, wherein the execution of the instructions by the at least one processor causing the at least one processor to transmit the data blocks into which the data are segmented to the transmission service platform over the selected at least two data transmission paths comprises:
execution of the instructions by the at least one processor causing the at least one processor to invoke a general-purpose interface to transmit the data blocks into which the data are segmented to the transmission service platform over the selected at least two data transmission paths.

8. The apparatus according to claim 5, the execution of the instructions by the at least one processor causing the at least one processor to transmit the data blocks into which the data are segmented to the transmission service platform over the selected at least two data transmission paths comprises:
execution of the instructions by the at least one processor causing the at least one processor to transmit the data blocks into which the data are segmented to the transmission service platform over the selected at least two data transmission paths in a general-purpose proxy protocol.

9. A non-transitory computer-readable storage medium storing executable instructions that, when executed by an electronic device with a touch-sensitive display, cause the electronic device to:
obtain at least two data transmission paths between the apparatus and a transmission service platform, and select at least two of the determined data transmission paths;
segment data to be transmitted into at least two data blocks; and transmit associated information of respective data blocks to the transmission service platform, wherein the associated information identifies the data to be transmitted to which the data blocks belong; and
transmit the data blocks into which the data are segmented to the transmission service platform over the selected at least two data transmission paths.

10. The non-transitory computer-readable storage medium according to claim 9, wherein the stored executable instructions that, when executed by an electronic device with a touch-sensitive display, further cause the electronic device to:
detect transmission rates of the selected respective data transmission paths while the transmitting module is transmitting the at least two data blocks into which the data are segmented to the transmission service platform over the selected data transmission paths after allocating the data blocks to the respective data transmission paths;
determine, for any one of the selected data transmission paths, whether the transmission rate thereof is less than a preset rate; and
if a result of the determination by the determining module is positive, allocate the data blocks to be transmitted, allocated to the data transmission path with the transmission rate less than the preset rate, to a data transmission path with the transmission rate more than the preset rate.

11. The non-transitory computer-readable storage medium according to claim 9, wherein the stored executable instructions that, when executed by an electronic device with a touch-sensitive display, cause the electronic device to transmit the data blocks into which the data are segmented to the transmission service platform over the selected at least two data transmission paths comprises:
the stored executable instructions that, when executed by an electronic device with a touch-sensitive display, cause the electronic device to invoke a general-purpose interface to transmit the data blocks into which the data are segmented to the transmission service platform over the selected at least two data transmission paths.

12. The non-transitory computer-readable storage medium according to claim 9, wherein the stored executable instructions that, when executed by an electronic device with a touch-sensitive display, cause the electronic device to transmit the data blocks into which the data are segmented to the transmission service platform over the selected at least two data transmission paths comprises:
the stored executable instructions that, when executed by an electronic device with a touch-sensitive display, cause the electronic device to transmit the data blocks into which the data are segmented to the transmission service platform over the selected at least two data transmission paths in a general-purpose proxy protocol.
